(19) United States
(12) Patent Application Publication
(10) Pub. No.: US 2014/0317220 A1
(43) Pub. Date: Oct. 23, 2014

(54) DEVICE FOR EFFICIENT USE OF PACKET BUFFERING AND BANDWIDTH RESOURCES AT THE NETWORK EDGE

(71) Applicant: PACKET ARCHITECTS AB, Södra Sandby (SE)

(72) Inventors: Per Karlsson, Malmo (SE); Lars Viklund, Horby (SE); Benny Andersson, Malmo (SE); Patrik Sundström, Osby (SE); Kenny Ranerup, Lund (SE); Robert Wikander, Sodra Sandby (SE); Daniel Ågren, Sodra Sandby (SE)

(21) Appl. No.: 14/355,830

(22) PCT Filed: Nov. 1, 2012
(86) PCT No.: PCT/EP2012/071667

§ 371 Date: May 1, 2014

Related U.S. Application Data
(60) Provisional application No. 61/556,162, filed on Nov. 4, 2011.

(51) Int. Cl. H04L 12/863; G06F 13/28

(52) U.S. Cl. CPC H04L 47/50; G06F 13/28
USPC 709/212

(57) ABSTRACT

The invention relates to a hybrid network device comprising a server interface enabling access to a server system memory, a network switch comprising a packet processing engine configured to process packets routed through the switch and a switch packet buffer configured to queue packets before transmission, at least one network interface; and at least one a bus mastering DMA controller configured to access the data of said server system memory via said at least one server interface and transfer said data to and from said hybrid network device. According to one aspect of the invention, a bus transfer arbiter configured to control the data transfer from the server memory to the packet processing engine of said hybrid network device.

### TECHNICAL FIELD

The present invention relates to the field of server network interface controllers and edge network switches, and especially targets the data center where a large number of closely situated server nodes are interconnected and connected to a network by a top-of-rack switch.

### BACKGROUND

In a data center the server nodes are typically densely packed in racks and interconnected by a top-of-rack switch, which is further interconnected with other top-of-rack switches in a data center network. Each server node has its own network interface accessible through the server peripheral bus. The network interface may be implemented either as a network interface controller in a server chip-set or as a separate network interface card, both implementations are abbreviated NIC. The NIC connects to a top-of-rack switch through a server side physical interface, a network cable, and a switch side physical interface.

The high density of server nodes in the data center places high demands on power efficiency and interconnection bandwidth, but also limits the length of the network cables from the server nodes to the edge network switch. Further, the distributed character of the applications typically hosted in the data center places high demands on low interconnection latency.

A NIC typically has access to the system memory of the server node via a PCI Express peripheral bus, and will move network packets to and from the server system memory by means of a bus mastering direct memory access (DMA) controller. The NIC will have a packet buffer memory for temporary storing both incoming and outgoing packets. The buffer memory is needed because immediate access to the server peripheral bus and server system memory typically cannot be guaranteed, while the NIC must be able to continually receive packets from the network and to transmit any packets initiated for transmission to the network at the line rate.

The typical NIC has no direct knowledge of the congestion status of the edge network switch. Packet drops can still be avoided using standardized flow control schemes such as IEEE 802.1Qbb, although it is coarse grained and it comes at a considerable cost in wasted network bandwidth and packet buffering in the edge network switch. The top-of-rack switch buffering resources may also have to be expanded in off-chip memories to achieve an acceptable network performance, and thus wasting valuable I/O bandwidth in the switch devices. This leads to an increased power consumption of the top-of-rack switch and thus places a limit on the achievable network connection density.

All in all the competitiveness of a data center is highly dependent on the achievable server node density and the capacity and speed of the server node interconnections. These metrics in turn rely on the density and power efficiency of the NIC and the edge network switch, on their bandwidth and latency, and in the end on the efficiency with which the bandwidth and packet buffering resources are utilized.

### SUMMARY OF THE INVENTION

With the above description in mind, an aspect of the present invention is to provide a way to supply the NIC with information of the state and size of the network packet queues in the network switch, thereby providing the NIC with the means to alleviate or eliminate one or more of the above-identified deficiencies in the art and disadvantages singly or in any combination.

The present invention takes advantage of the short physical distance from the server node the to the first network switch in a data center environment, to reduce latency and host system complexity by combining NIC functionality with the network switch into a hybrid network device. Hence, the inventors have realized that the NIC functionality may be distributed to the network switch, by adding a bus mastering direct memory access controller to the hybrid network device. This reduces the total necessary number of components used in the server and network switch system as a whole. Furthermore, the data transfer from the server memory to the packet processing engine of said hybrid network device may be controlled from the hybrid network device.

Furthermore, a choice can be made between a complete or a deferred packet transfer. In a deferred packet transfer only parts of the packet is initially read from server system memory. This allows a device based on the present invention the freedom to use the available bandwidth resources to inspect packets earlier than a traditional edge network switch could, leading to a better informed packet arbitration decision.

Furthermore, the present invention makes more efficient use of the available packet buffering and bandwidth resources by deferring or eliminating packet data transfer. Hence, a deferred data transfer is beneficial in that the freed-up bandwidth allows an earlier inspection of additional packet headers thus enabling better packet arbitration.

According to one aspect of the invention it relates to a hybrid network device comprising:
at least one server interface enabling access to a server system memory;
a network switch comprising a packet processing engine configured to process packets routed through the switch and a switch packet buffer configured to queue packets before transmission;
at least one network interface; and
at least one a bus mastering DMA controller configured to access the data of said server system memory via said at least one server interface and transfer said data to and from said hybrid network device.

According to one aspect of the invention it relates to a hybrid network device, further comprising:
a bus transfer arbiter configured to control the data transfer from the server memory to the packet processing engine of said hybrid network device.

According to one aspect of the invention it relates to a hybrid network device, wherein said control is based on available resources in the network switch.

According to one aspect of the invention it relates to a hybrid network device, wherein the control is further based on packets queued in the server nodes.

According to one aspect of the invention it relates to a hybrid network device, wherein the control is conditioned upon a software controlled setting.

According to one aspect of the invention it relates to a hybrid network device wherein a bus mastering DMA controller is configured to transfer less than a full packet and enough data for the packet processing engine to initiate packet processing.

According to one aspect of the invention it relates to a hybrid network device wherein a bus mastering DMA controller is configured to transfer less than a full packet and at least the amount of data needed to begin the packet processing.

According to one aspect of the invention it relates to a hybrid network device wherein a bus mastering DMA controller is configured to defer the transfer of rest of the packet.

According to one aspect of the invention it relates to a hybrid network device, wherein the hybrid network device is configured to store packet processing results until a data transfer is resumed, such that packet processing does not need to be repeated when a deferred packet transfer is resumed.

According to one aspect of the invention it relates to a hybrid network device, wherein the hybrid network device is configured to store packet data until a data transfer is resumed, such that less than the full packet needs to be read from server system memory when a deferred packet transfer is resumed.

According to one aspect of the invention it relates to a hybrid network device, wherein the hybrid network device is further configured to discard the packet data remaining in said server system memory, when a packet is dropped, such that said remaining data is not transferred to the hybrid network device.

According to one aspect of the invention it relates to a hybrid network device, wherein the bus mastering DMA controller connects to a server node using PCI Express.

According to one aspect of the invention it relates to a hybrid network device, wherein the network switch processes Ethernet packets.

According to one aspect of the invention it relates to a hybrid network device, wherein deferring packet data transfer is conditioned upon packet size, available bandwidth resources, available packet storage resources, packet destination queue length, or packet destination queue flow control status.

According to one aspect of the invention it relates to a hybrid network device, wherein resuming the deferred packet data transfer is conditioned upon available bandwidth resources, available packet storage resources, packet destination queue length, position of the packet in the packet destination queue, packet destination queue flow control status, or the completion of packet processing.

According to one aspect of the invention it relates to a hybrid network device comprising:
a bus mastering DMA controller; and
a network switch
wherein data transfer to the network switch by the DMA controller is scheduled based on available resources in the network switch.

According to one aspect of the invention it relates to a hybrid network device wherein the bus mastering DMA controller connects to a server node using PCI Express.

According to one aspect of the invention it relates to a hybrid network device wherein the network switch processes Ethernet packets.

According to one aspect of the invention it relates to a hybrid network device wherein transfer of packet data from a server node to the hybrid network device is postponed when said data is not needed to determine the packet destination.

According to one aspect of the invention it relates to a hybrid network device wherein a determined packet destination is stored until a data transfer is resumed.

According to one aspect of the invention it relates to a hybrid network device wherein a determined packet destination is discarded before a transfer is resumed.

According to one aspect of the invention it relates to a hybrid network device wherein a decision to defer the complete packet transfer is conditioned upon a software controlled setting.

According to one aspect of the invention it relates to a hybrid network device wherein postponing a packet data transfer is conditioned upon packet size.

According to one aspect of the invention it relates to a hybrid network device wherein postponing a packet data transfer is conditioned upon available bandwidth resources.

According to one aspect of the invention it relates to a hybrid network device wherein postponing a packet data transfer is conditioned upon available packet storage resources.

According to one aspect of the invention it relates to a hybrid network device wherein postponing a packet data transfer is conditioned upon packet destination queue lengths.

According to one aspect of the invention it relates to a hybrid network device wherein postponing a packet data transfer is conditioned upon packet destination queue flow control status.

According to one aspect of the invention it relates to a hybrid network device wherein resuming a postponed packet data transfer is conditioned upon the available bandwidth resources.

According to one aspect of the invention it relates to a hybrid network device wherein resuming a postponed packet data transfer is conditioned upon the available packet storage resources.

According to one aspect of the invention it relates to a hybrid network device wherein resuming a postponed packet data transfer is conditioned upon the destination queue length.

According to one aspect of the invention it relates to a hybrid network device wherein resuming a postponed packet data transfer is conditioned upon the position of the packet in the destination queue.

According to one aspect of the invention it relates to a hybrid network device wherein resuming a postponed packet data transfer is conditioned upon the packet destination queue flow control status.

According to one aspect of the invention it relates to a hybrid network device wherein resuming a postponed packet data transfer is conditioned upon the completion of packet processing.

According to one aspect of the invention it relates to a hybrid network device wherein packet data which is not needed for the decision to drop the packet is not transferred to the device when a packet is actively dropped in the device.

A first aspect of the present invention relates to a method of integrating the network interface controller and a network switch into a hybrid network edge device.

A second aspect of the present invention relates to a method for keeping the network interface controller informed of the state of the network switch and using that information for scheduling transfers from the system memory of locally connected servers to the network switch.

A third aspect of the present invention relates to a method for deferring packet data transfer from server system memory to the network switch.

A fourth aspect of the present invention relates to a method for deferring packet data transfer from server system memory to the network switch, where the packet processing results are stored so that less than the full packet needs to be read from server system memory when the deferred packet transfer is resumed.

A fifth aspect of the present invention relates to a method of selecting when to defer packet data transfer from server system memory, thereby maintaining low latency while providing the benefits of the third aspect.

A sixth aspect of the present invention relates to a method of conserving network switch buffering resources, where the packet processing results is selectively thrown away, necessitating repeated packet processing.

A seventh aspect of the present invention relates to a method for conserving server system memory bandwidth and bus bandwidth by eliminating the need for reading parts of a dropped packet.

Any of the features in the aspects of the present invention above may be combined in any way possible to form different variants of the present invention.

### BRIEF DESCRIPTION OF THE DRAWINGS

Further objects, features, and advantages of the present invention will appear from the following detailed description of some embodiments of the invention, wherein some embodiments of the invention will be described in more detail with reference to the accompanying drawings, in which:

FIG. 1 shows a system where several server nodes are connected to an edge network switch;

FIG. 2 shows a packet transmitted to the network by application software in a typical prior art system;

FIG. 3 shows a system where several server nodes are connected to a hybrid network device according to an embodiment of the present invention;

FIG. 4 shows a packet transmitted to the network by application software according to an embodiment of the present invention; and

FIG. 5 shows a block diagram according to an embodiment of the present invention; and

FIG. 6 shows a flow diagram for packet reception from an Ethernet interface according to an embodiment of the present invention; and

FIG. 7 shows a flow diagram for packet transmission from a software application according to an embodiment of the present invention; and

FIG. 8 shows a flow diagram for the bus transfer arbitration according to an embodiment of the present invention; and

FIG. 9 shows a flow diagram describing queuing of a packet received on a peripheral bus interface in a transmit queue according to an embodiment of the present invention; and

FIG. 10 shows a flow diagram of the decision to resume a deferred packet transfer according to an embodiment of the present invention; and

FIG. 11 shows a flow diagram for the transfer of a resumed packet from server memory; and

FIG. 12 shows a flow diagram of the network transfer arbiter according to an embodiment of the present invention; and

FIG. 13 shows a flow diagram for the transfer of a packet to server memory according to an embodiment of the present invention; and

FIG. 14 shows a flow diagram for the transmission of a packet on an Ethernet interface according to an embodiment of the present invention.

### DETAILED DESCRIPTION

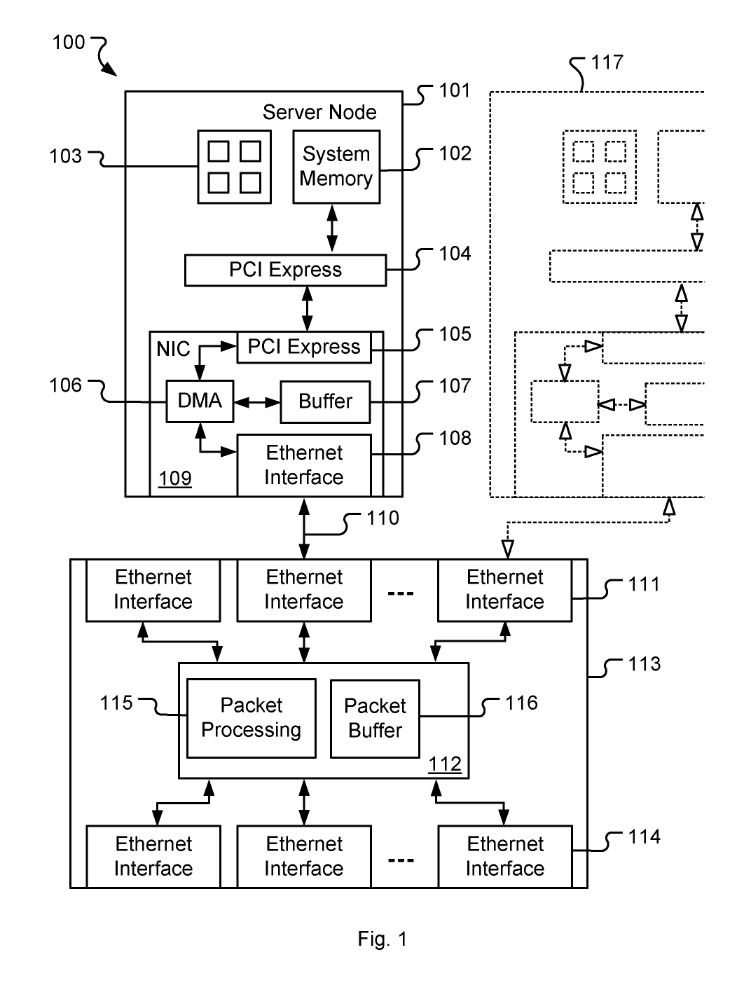

The present invention will be exemplified using a PCI Express server peripheral bus and an Ethernet network, but could be implemented using any network and peripheral bus technology. A typical network system 100 according to prior art is presented in FIG. 1, where a server node 101, comprising a NIC 109, and a network switch 113 are interconnected via an Ethernet link 110. The server side Ethernet connection is provided by said NIC 109 connected to a server PCI Express bus 104. The NIC 109 is comprised of a PCI Express endpoint 105, a packet buffer 107, an Ethernet interface 108 and a bus mastering DMA controller 106 that handles the data transfer between the server system memory 102 and the NIC packet buffer 107 via the PCI Express bus 104. Each packet created in the server system memory 102, and queued for transmission, will be fetched by the DMA controller 106 via the PCI Express bus 104, stored in the packet buffer 107 and transmitted on the Ethernet interface 108 to the network switch 113. Packets received on the NIC Ethernet interface 108 from the network switch 113 are stored in the packet buffer 107, written to the server system memory 102 by the DMA controller 106 via the PCI Express bus 104, and queued for processing by the server software running on the server CPUs 103. The network switch 113 is comprised of a number of server facing Ethernet interfaces 111, a number of network facing Ethernet interfaces 114, and a switch core 112 comprising a packet processing engine 115 and a packet buffer 116. There are typically multiple server facing Ethernet interfaces 111 (as indicated in the figure) each connecting to a server node 101,117. For each incoming packet the packet processing engine 115 will inspect the packet headers, and based on that inspection and the current resource status, the network switch 113 will either drop the packet or forward it to one or several Ethernet interfaces 111,114. Before a packet is forwarded it may also be modified based on the packet headers.

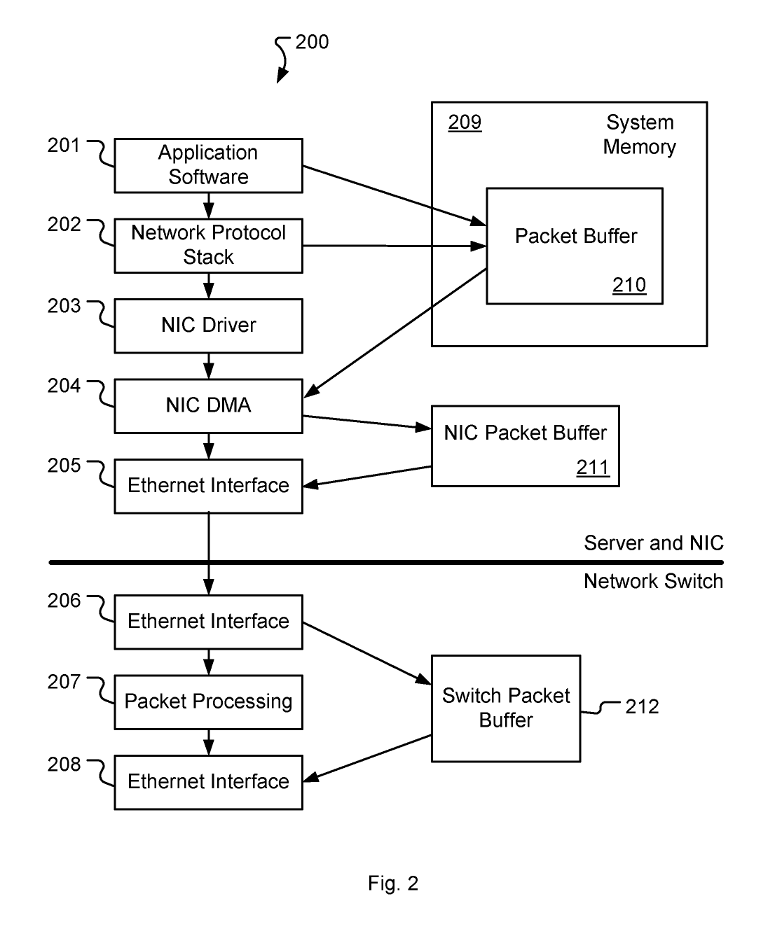

A packet processing sequence 200, according to prior art, describing how packets are transmitted to the network by a server software application is illustrated in FIG. 2. The application software 201 executing on the server node prepares data to be transmitted by writing it to a packet buffer 210 in a server system memory 209. A handle to the data is then passed to the network protocol stack 202. The network protocol stack 202 will parcel the data into packets, expanding each by adding network headers before the packet data. Handles to the packets in the server system memory 209 are handed to the NIC driver 203, which in turn passes them over to the NIC DMA controller 204. Each packet is moved from the server system memory 209 to the NIC packet buffer 211 by the NIC DMA controller 204, and transmitted on the Ethernet interface 205 at the line-rate. When a packet arrives at the network switch by the Ethernet interface 206 the packet header is extracted and sent to packet processing 207. The packet data is stored in the switch packet buffer 212. Based on the result of the packet processing 207 and the resource status in the switch, the packet is either dropped or queued for transmission on one or several Ethernet interfaces 208.

To avoid depleting the buffering resources 116 in the network switch 113, standards compliant pause frames can be constructed and sent from the switch to one or several connected Ethernet interfaces 108. When a pause frame is received by an Ethernet interface 108 supporting flow control, the packet transmission is suspended for a period of time indicated in the frame. The granularity of the flow control is limited by the lack of out-of-band signaling and thus reliant on available standards, such as IEEE 802.1Qbb. The packet buffering 107,116 in each end must be dimensioned to account for both the round trip latency of the Ethernet connections 110 and the transmit time of a maximum sized Ethernet frame.

In a prior art system the intermediary buffering in the NIC incurs a cost in latency and power consumption.

Once a packet transfer is initiated in the prior art it will always be completed in its entirety. Thus a packet due for transmission in a server node or switch will always be either dropped or transferred in its entirety before a later packet can be transferred. Consequently a low priority packet can introduce latency in a higher priority packet stream by temporarily blocking the transmission of higher priority packets.

In the prior art a packet may be transferred from the server node to the switch packet buffer even though the egress destination queue is congested, potentially wasting ingress bandwidth and switch packet buffer space. This unconditional packet transfer can also hide network congestion issues from the server applications.

In the prior art a transient lack of server node resources may lead to a dropped packet even though there is no global resource shortage in the system.

An embodiment of the present invention will be described more fully hereinafter with reference to the accompanying drawings. This invention may, however, be embodied in many different forms and should not be construed as limited to the embodiment and variations set forth herein. Rather, this embodiment and the variations are provided so that this disclosure will be thorough and complete, and will fully convey the scope of the invention to those skilled in the art. Like reference signs refer to like elements throughout.

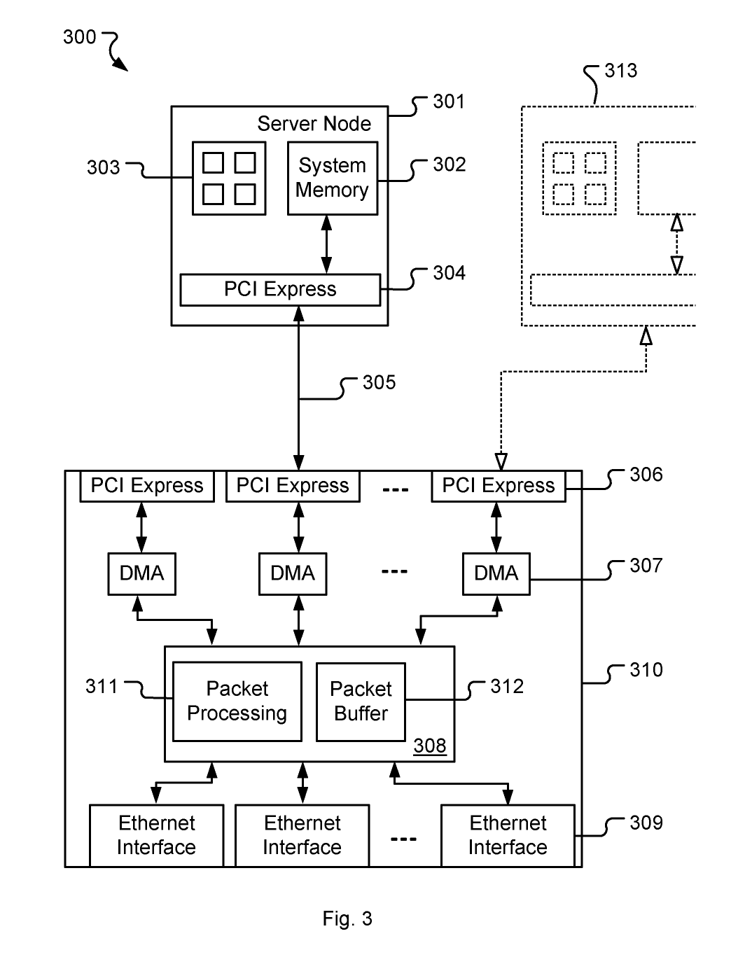

An overview of a network system utilizing a hybrid network device 300 based on the present invention is depicted in FIG. 3. The hybrid network system 300 comprises a server node 301, without a NIC, and a hybrid network device 310, where a PCI Express server peripheral bus 304 in said server node 301 is extended 305 to reach the hybrid network device 310. The hybrid network device 310 includes at least one PCI Express endpoint 306, at least one bus mastering DMA controller 307, at least one Ethernet interface 309 and a switch core 308. The at least one DMA controller 307 allows access to the server system memory 302 of the server node 301 independent of the server CPUs 303 in the hybrid node 301. The switch core 308, in the hybrid network device 310, comprises a packet buffer 312 and a packet processing engine 311.

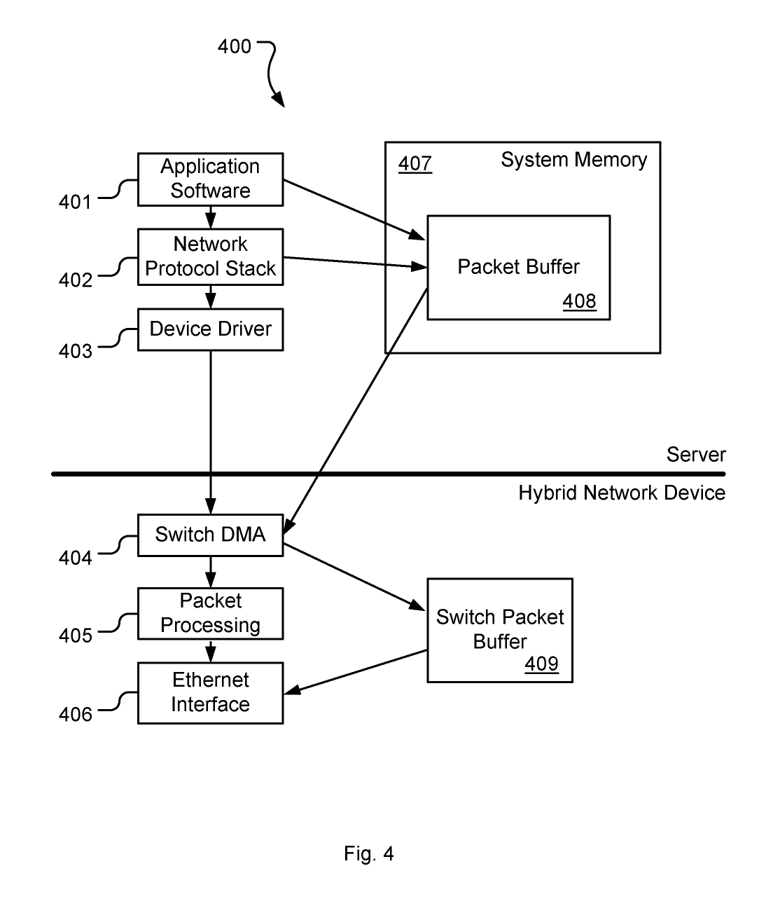

A packet processing sequence 400, of a hybrid network system according to the present invention, describing how packets are transmitted to the network by a server software application is illustrated in FIG. 4. Many such sequences may be active simultaneously in the hybrid network system. The application software 401 executing on the server node 301 prepares data to be transmitted by writing the data to a packet buffer 408 in a server system memory 407, and then passes a handle for the data to the network protocol stack 402. The network protocol stack 402 will parcel the data into packets, expanding each by adding network headers before the packet data. Handles to the packets in system memory 407 are handed to the hybrid network device driver 403, which in turn hands them over to the switch DMA controller 404. Packets are, completely or in part, moved from server system memory 407 to the hybrid network device where the packet headers are extracted and sent to packet processing 405, while the packet data is stored in the switch packet buffer 409 in the hybrid network device. In the prior art the complete packet would be transferred from server system memory, but in the present invention a choice can be made between a complete or a deferred packet transfer. In a deferred packet transfer only parts of the packet are initially read from server system memory. The decision to defer the completion of the packet transfer may be taken on a per packet basis by the DMA controller 307.

Based on the result of the packet processing 405 and the resource status in the hybrid network device the packet is either dropped or queued for transmission on one or several Ethernet interfaces 406 or the like.

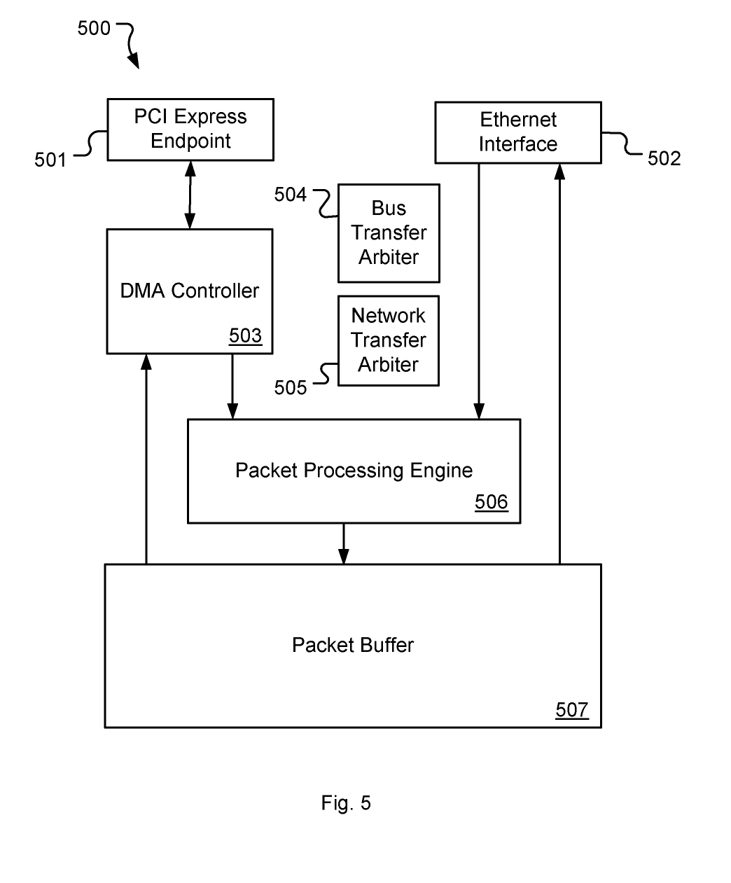

A more detailed block diagram of a hybrid network device 500 according to an embodiment of the present invention is shown in FIG. 5. The hybrid network device 500 comprises at least one PCI Express endpoint 501, at least one bus mastering DMA controller 503, a bus transfer arbiter 504, a packet processing engine 506, a packet buffer 507, a network transfer arbiter 505, and an Ethernet interface 502. The PCI Express endpoint 501 enables access to server system memory 302 from the hybrid network device 310 via the server PCI Express bus 304. The DMA controller 503, connected to the PCI express endpoint 501, transfers packet data and related meta data to and from the server system memory 302 in the server node 301. The bus transfer arbiter 504 controls access to the peripheral bus 304 from the hybrid network device 310, and selects which packet data to transfer from server system memory 302 to the packet processing engine 506 of the hybrid network device 310. This selection may be based on information of packets queued in both the server nodes 301 313 (if multiple server nodes are present) and the hybrid network device packet buffer 507. The packet processing engine 506 determines destination and egress format of the packet. Various operations may also be performed, such as setting a packet priority. The packet buffer 507 stores packets until they are scheduled to be transmitted on an interface. The destination may be either an Ethernet interface 502 or a PCI Express endpoint 501. The network transfer arbiter 505 selects which of the packets queued in the packet buffer 507 to transfer. This selection is based on attributes from packet processing and on available resources. The Ethernet interface 502 enables network access. The hybrid network device 310 may include none, one or several of these interfaces.

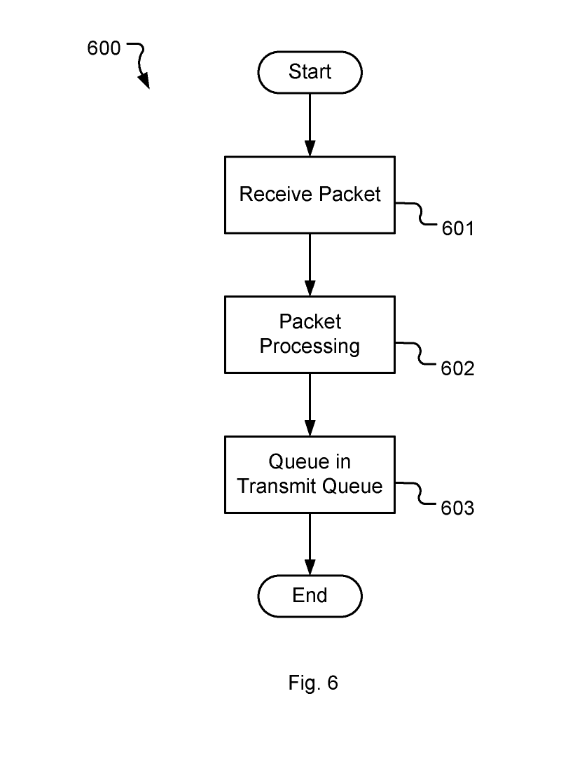

A flowchart 600 describing the process of packet reception from the network in a hybrid network device 500, according to an embodiment of the present invention, is shown in FIG. 6. Packets are received by one or more Ethernet interfaces 601,502 and are presented to the packet processing 602,506 engine in a first-come-first-serve manner. The packet data is stored in the packet buffer 507, awaiting the completion of the packet processing 602,506. Once packet processing is finished a handle for the packet is placed in a transmit queue 603 awaiting arbitration by the network transfer arbiter 505 both in the hybrid network device 500.

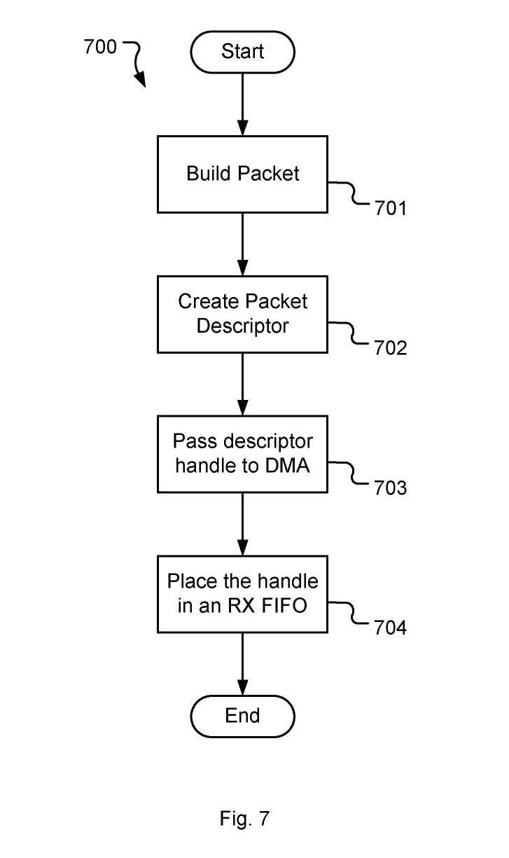

A flowchart 700 describing the process of packet transmission from a software application 401 executing on a server node 301 connected to a hybrid network device 310, according to an embodiment of the present invention, is shown in FIG. 7. Software builds the packet 701 and a packet descriptor 702 in the server system memory 302 in the server node 301. The packet descriptor comprises handles for packet data and packet meta data. A handle for the packet descriptor is presented 703 to the hybrid network device 310 by writing the handle to a hardware register within the hybrid network device 310 via the server node 301 peripheral bus interface, which in this case is a PCI express interface 304,305,306. The DMA 307 within the hybrid network device 310 will queue the pointer in a receive first-in-first-out (RX FIFO) 704 awaiting bus transfer arbitration 504. Each handle in the RX FIFO has a one-to-one correspondence with a packet in server system memory 302 in the server node 301. There may be more than one RX FIFO per bus connection (as shown in FIG. 3), each fed from its own hardware register.

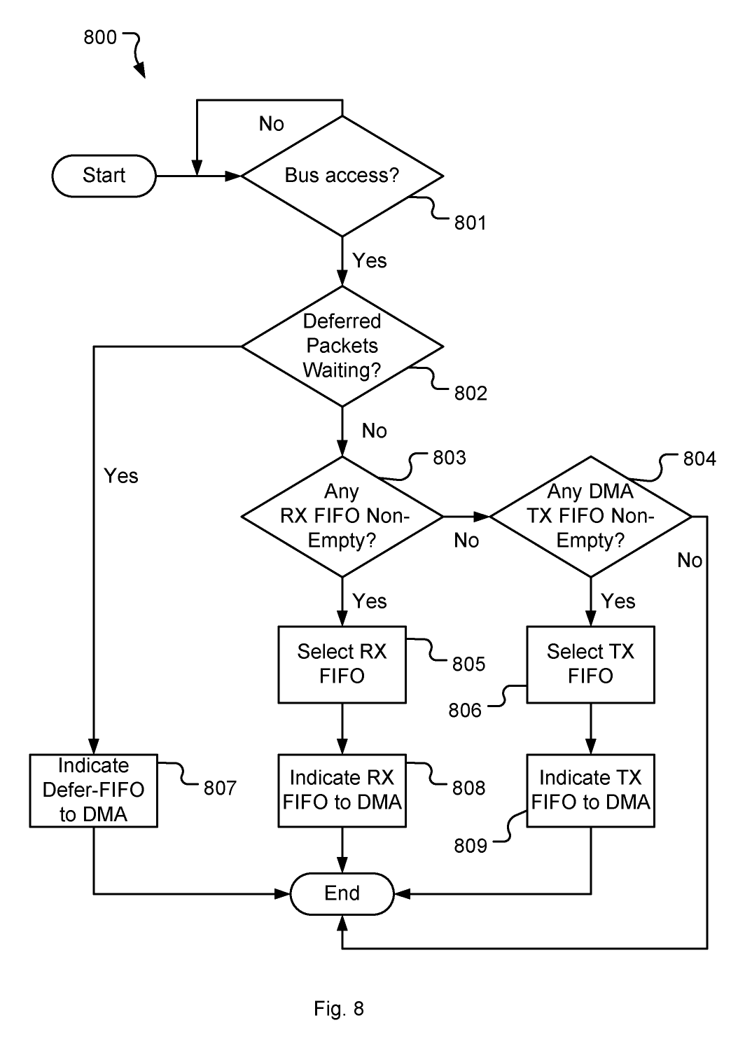

A flow diagram of the bus transfer arbitration 800 in a hybrid network device 500 according to an embodiment of the present invention is shown in FIG. 8. The arbitration has two facets, the packet arbitration (comprising the steps 805 and, 806) and the bus arbitration (comprising the steps 801,802,803 and 804). Bus arbitration prevents the fetching of descriptors and headers from choking the transfer of complete packets, and balances the bandwidth allotted for receive and transmit transfers. This is achieved by first giving strict precedence to the completion of deferred packet transfers over the initiation of new packet transfers 802, and then giving strict precedence to the initiation of receive packet transfers over the initiation of transmit packet transfers 803. Receive packets are selected 805 by choosing one of the non-empty RX FIFOs. The RX FIFO is selected by first choosing the peripheral bus connections with non-empty RX FIFOs in a round-robin manner, and then choosing among the RX FIFOs belonging to the same bus in a strict priority order. Transmit packets are selected 806 by choosing one of the non-empty transmit first-in-first-outs (TX FIFOs). The TX FIFO is selected by first choosing the peripheral bus connections with non-empty TX FIFOs in a round robin manner, and then choosing among the TX FIFOs belonging to the same bus in a strict priority order. When a FIFO has been chosen the DMA controller is notified of the decision 807,808,809.

NICs and integrated NICs and switches in the prior art transfers complete packets between the server node memory and the switch buffer memory. In the prior art it may be possible to begin packet processing before the completion of a packet transfer, while in the present invention the DMA controller has the capability of fetching partial packets and presenting the packet headers to the packet processing engine, while deferring or aborting transfer of the complete packet thus conserving switch packet buffering and bandwidth resources

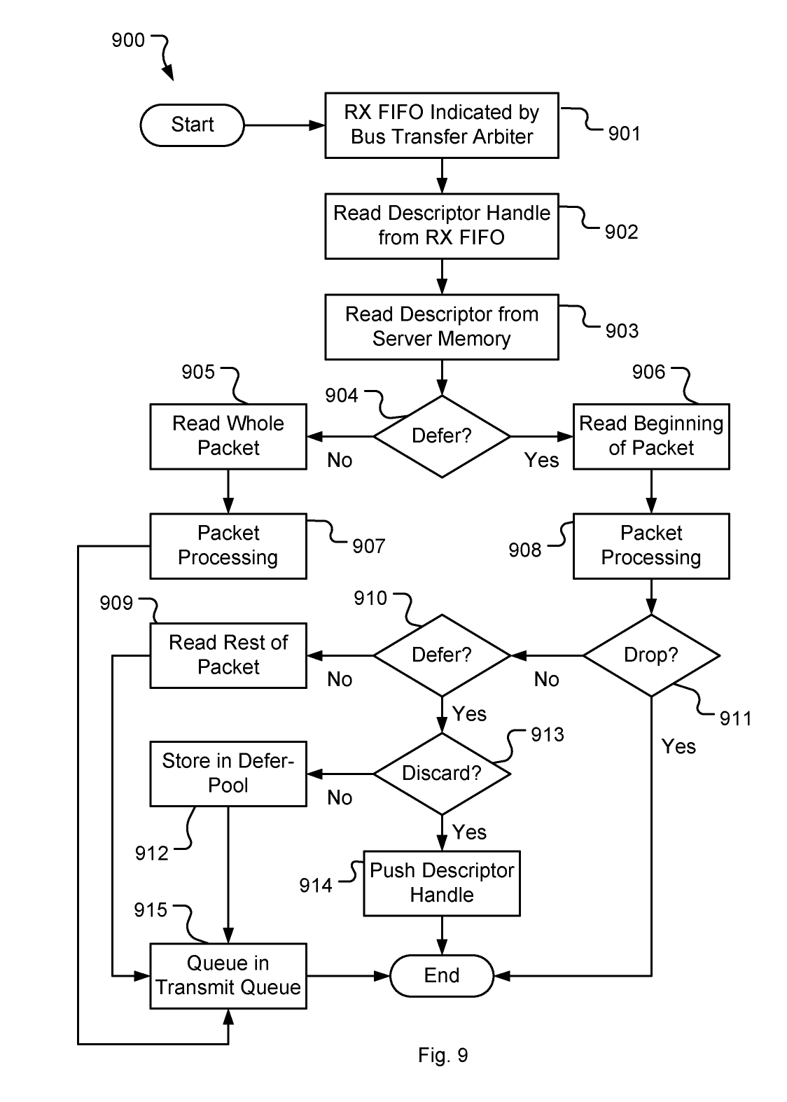

FIG. 9 shows the steps taken, according to an embodiment of the present invention, from the point where a packet transfer from a server node 301 to the hybrid network device 310 has been decided, to the point where the packet is queued for transmission from the hybrid network device 310. When the bus transfer arbiter has initiated a receive transfer by indicating an RX FIFO 901, the DMA controller 307 reads the descriptor handle from the RX FIFO 902 and uses the handle to read the descriptor from server system memory 302 through the server system bus interface 903. In the prior art the complete packet would be transferred from server system memory, but in the present invention a choice can be made between a complete or a deferred packet transfer 904,910. In a deferred packet transfer only parts of the packet is initially read from server system memory. The decision to defer the completion of the packet transfer may be taken on a per packet basis by the DMA controller 307. This allows a device based on the present invention the freedom to use the available bandwidth resources to inspect packets earlier than a traditional edge network switch could, leading to a better informed packet arbitration decision. This results in a better utilization of available bandwidth and buffer resources. There are several methods for making the decision to defer 904 the complete packet transfer. According to the present invention different variations for making the decision to defer 904 the complete packet transfer may be;

I) to use a software controlled setting,

II) to base the decision on a packet size threshold, where packets above the threshold size will always be deferred,

III) to base the decision on a threshold for the available bandwidth resources, where all packets will be deferred when the available resources are below the threshold, and

IV) to base the decision on a threshold for the available packet buffering resources, where all packets will be deferred when the available resources are below the threshold,

V) to base the decision on a threshold for the packet destination queue length, where all packets aimed for the destination queue will be deferred when the queue length is above the threshold, and

VI) to base the decision on the flow control status for the packet destination queue, where all packets aimed for the destination queue will be deferred when the queue is paused.

Concurrently the beginning of the packet is fetched from server node memory using the packet data handles in the packet descriptor 905,906. The amount of data fetched is at least the amount needed to begin the packet processing. As it is read the first part of the packet is presented to the packet processing engine 907,908. The result of the packet processing is a destination, instructions for packet modification, and quality of service attributes. When results of the packet processing for a deferred packet are available the packet can in the present invention be dropped without an additional bandwidth cost 911. If the packet is not dropped the packet is either read in its entirety 909 or deferred further. The processing results can still be discarded for a deferred packet 913, but it necessitates that the packet handle is pushed back to the RX FIFO 914 to be processed again at a later time. For a deferred packet that is neither discarded nor dropped the descriptor is stored in the defer-pool 912 awaiting a resume decision. For a deferred packet the amount of data fetched is written to the descriptor. Any packet that is not dropped or discarded is placed in a transmit queue 915, based on the destination and the quality of service attributes, awaiting network arbitration. For queued packets packet data and the results of the packet processing are stored in the packet buffer.

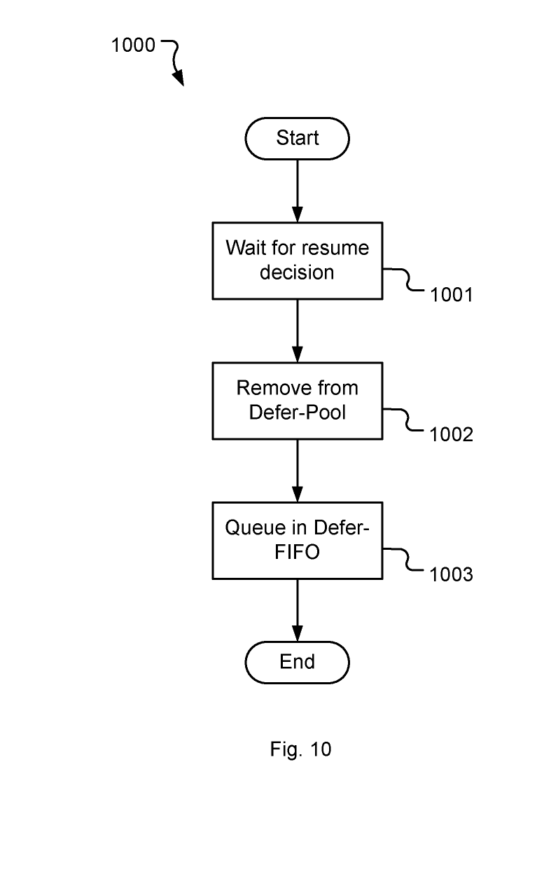

The process of resuming a deferred packet transfer 1000 in the embodiment of the present invention is shown FIG. 10. There are several methods for taking the decision to initiate the completion of the packet transfer 1001. According to the present invention different variations taking the decision to initiate the completion of the packet transfer 1001 may be;

I) to initiate the completion of the packet transfer when there is available bandwidth,

II) to initiate the completion of the packet transfer when packet buffering resources have become available,

III) to initiate the completion of the packet transfer when the number of packets or the amount of packet data ahead of the packet in the transmit queue is below a threshold,

IV) to initiate the completion of the packet transfer when the packet destination queue has been determined and the size of that queue is below a threshold,

V) to initiate the completion of the packet transfer when the flow control status for the packet destination queue changes from paused to not paused, and

VI) to initiate the completion of the packet transfer when the packet processing is finished.

When the decision to resume the deferred packet transfer has been taken the packet descriptor is removed from the defer-pool 1002 and placed in the defer-FIFO 1003 awaiting bus arbitration.

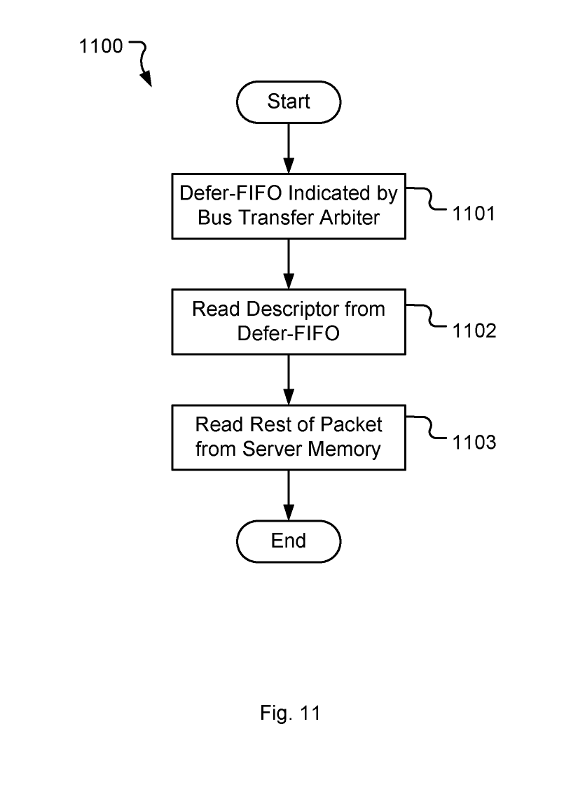

FIG. 11 shows a flow diagram 1100 of the steps taken when the defer-FIFO is chosen by the bus transfer arbiter 1101, according to an embodiment of the present invention. First the descriptor is read from the defer-FIFO 1102, and then the remainder of the packet is read from server system memory utilizing the packet handle and the indicated amount previously read as stored in the descriptor 1103.

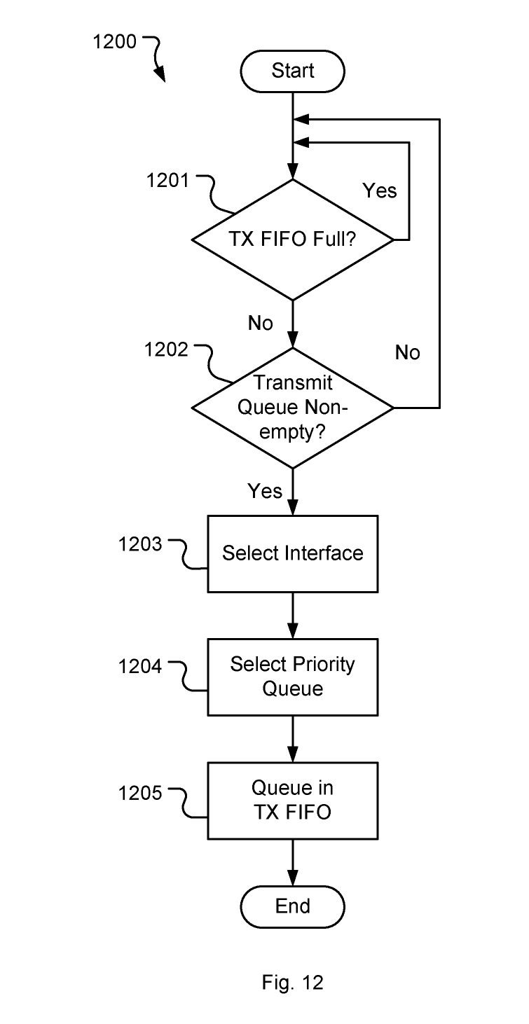

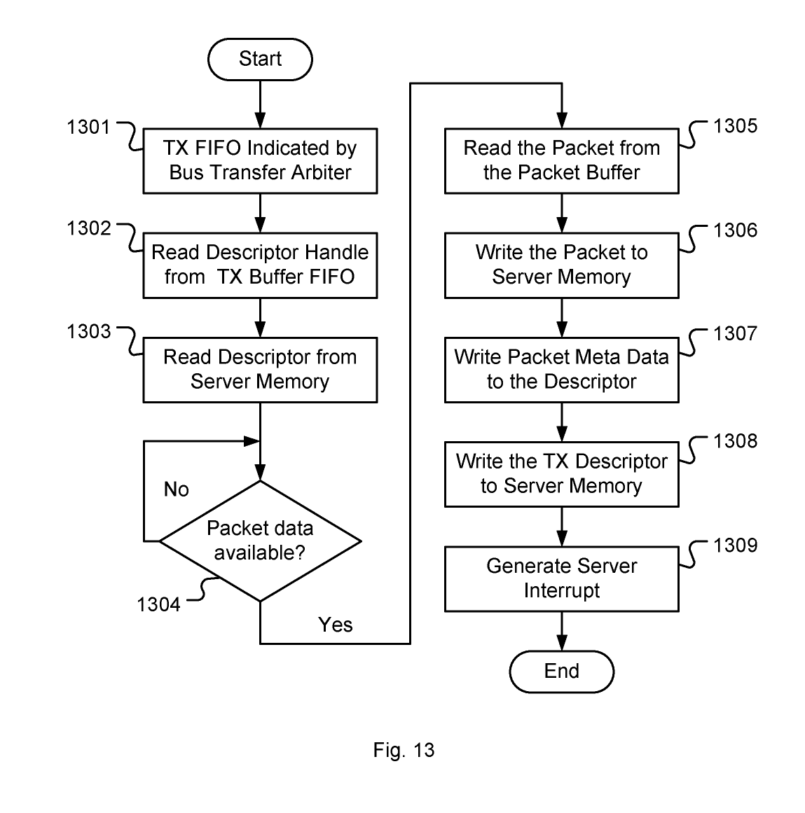

FIG. 12 shows a flow diagram 1200 of the network transfer arbitration, according to an embodiment of the present invention. Packet transmission decisions are queued in the TX FIFOs, and each Ethernet interface and each bus interface is mapped to a TX FIFO. When there is free space in a TX FIFO 1201 and there is at least one packet queued for network arbitration in the transmit queues 1202 a transmit queue can be selected 1203,1204. The transmit queue is selected by first choosing the transmit interfaces 1203 with non-empty transmit queues in a round-robin manner, and then choosing among the transmit queues 1204 belonging to the same interface in a strict priority order. When a transmit queue 1203,1204 has been selected the packet handle at the head of the queue is moved to the TX FIFO 1205. Packet transfer to a server node directly connected to the hybrid network device via a server peripheral bus interface is entirely controlled by the hybrid network device DMA controller. The DMA controller writes the packet directly to server system memory, and only once the packet is fully transferred is it presented to the software executing on the server. A flow diagram 1300 for this process is shown in FIG. 13.

The server software pre-allocates buffers to hold received packets, and creates buffer descriptors comprised of handles for the allocated buffers and additional space for packet meta data. Handles for the buffer descriptors are presented to the hybrid network device by writing them to a hardware register within the device via the server peripheral bus interface. The DMA controller places the handles in a TX buffer FIFO waiting for a transmit packet transfer.

When the bus transfer arbiter has initiated a transmit transfer by indicating an TX FIFO 1301 the DMA controller reads a handle for an empty buffer descriptor from the TX buffer FIFO 1302 and then uses the handle to read the descriptor from server system memory through the server system bus interface 1303.

When packet data is available 1304 the packet is read from the packet buffer 1305 and written to server system memory via the server peripheral bus 1306 using the data handles in the empty buffer descriptor. The descriptor is then filled with packet meta data 1307 and written back to server system memory 1308. Once the packet data and the descriptor are transferred to server system memory a server interrupt is generated 1309 notifying the server software of the transmitted packet.

Server software will replenish the TX buffer FIFO with new empty buffer descriptor handles as they are consumed.

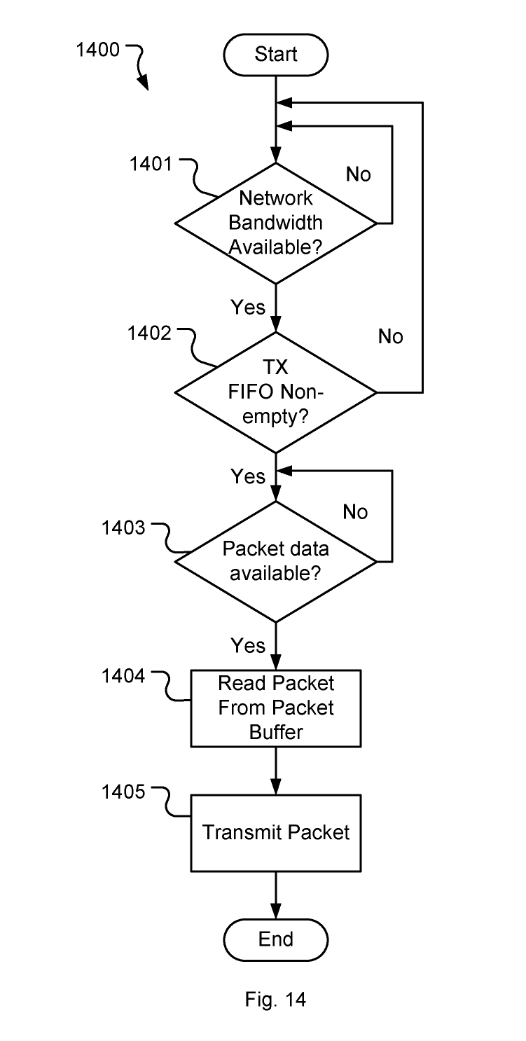

Packet transmission initiation for an Ethernet interface in the embodiment of the present invention is illustrated in FIG. 14. A transmission can only be initiated when there is available network bandwidth 1401 and there is at least one packet queued for transmission in the TX FIFOs 1402. When enough packet data is available to allow packet transmission at the Ethernet interface line-rate 1403 the packet is read from the packet buffer 1304 and transmitted on the Ethernet interface 1405. The transmission is initiated by the network transfer arbiter, but is then dictated by the line rate of the network interface.

Overall, in the present invention the packet buffering and handling in the NIC is bypassed allowing a direct connection between the server node memory and the switch packet buffer, thus allowing better flow control, better bandwidth utilization, better utilization of packet buffer resources, lower latency, lower packet drop rates, lower component count, lower power consumption and higher integration.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The foregoing has described the principles, preferred embodiments and modes of operation of the present invention. However, the invention should be regarded as illustrative rather than restrictive, and not as being limited to the particular embodiments discussed above. The different features of the various embodiments of the invention can be combined in other combinations than those explicitly described. It should therefore be appreciated that variations may be made in those embodiments by those skilled in the art without departing from the scope of the present invention as defined by the following claims.

1. A hybrid network device comprising:
at least one server interface enabling access to a server system memory;
a network switch comprising a packet processing engine configured to process packets routed through the switch and a switch packet buffer configured to queue packets before transmission;
at least one network interface; and
at least one a bus mastering DMA controller configured to access the data of said server system memory via said at least one server interface and transfer said data to and from said hybrid network device.

2. A hybrid network device according to claim 1, further comprising:
a bus transfer arbiter configured to control the data transfer from the server memory to the packet processing engine of said hybrid network device.

3. A hybrid network device according to claim 2, wherein said control is based on available resources in the network switch.

4. A hybrid network device according to claim 2, wherein the control is further based on packets queued in the server nodes.

5. A hybrid network device according to claim 2, wherein the control is conditioned upon a software controlled setting.

6. A hybrid network device according to claim 1 wherein the bus mastering DMA controller is configured to transfer less than a full packet and enough data for the packet processing engine to initiate packet processing.

7. A hybrid network device according to claim 1 wherein the bus mastering DMA controller is configured to transfer less than a full packet and at least the amount of data needed to begin the packet processing.

8. A hybrid network device according to claim 6 wherein the bus mastering DMA controller is configured to defer the transfer of rest of the packet.

9. A hybrid network device according to claim 8, wherein the hybrid network device is configured to store packet processing results until a data transfer is resumed, such that packet processing does not need to be repeated when a deferred packet transfer is resumed.

10. A hybrid network device according to claim 9, wherein the hybrid network device is configured to store packet data until a data transfer is resumed, such that less than the full packet needs to be read from server system memory when a deferred packet transfer is resumed.

11. A hybrid network device according to claim 1, wherein the hybrid network device is further configured to discard the packet data remaining in said server system memory, when a packet is dropped, such that said remaining data is not transferred to the hybrid network device.

12. A hybrid network device according to claim 1 wherein the bus mastering DMA controller connects to a server node using PCI Express.

13. A hybrid network device according to claim 1 wherein the network switch processes Ethernet packets.

14. A hybrid network device according to claim 8 wherein deferring packet data transfer is conditioned upon packet, size, available bandwidth resources, available packet storage resources, packet destination queue length, or packet destination queue flow control status.

15. A hybrid network device according to claim 9 wherein resuming the deferred packet data transfer is conditioned upon available bandwidth resources, available packet storage resources, packet destination queue length, position of the packet in the packet destination queue, packet destination queue flow control status, or the completion of packet processing.
